(19) United States
(12) Patent Application Publication
(10) Pub. No.: US 2012/0000335 A1
(43) Pub. Date: Jan. 5, 2012

(54) CUTTER BAR

(75) Inventor: Jochen Scheurich, Niedernberg (DE)

(73) Assignee: AUTOMATIK PLASTICS MACHINERY GMBH, Grossostheim (DE)

(21) Appl. No.: 13/111,905

(22) Filed: May 19, 2011

(30) Foreign Application Priority Data
Jul. 1, 2010 (DE) 102010025724.9

(51) Int. Cl. B26D 1/25; B26D 3/00

(52) U.S. Cl. 83/592; 83/835

(57) ABSTRACT

A cutter bar of a cutting device for producing pellets from strands of material that emerges from a perforated plate in one or more strands of material and is cut into individual pellets by the cutting device, having at least one cutting edge. The cutter bar can have a serration on at least one strand contact surface, and the serration can have a preferential direction that is inclined at an angle relative to the cutting edge.

### CROSS REFERENCE TO RELATED APPLICATIONS

The present patent application claims priority to and the benefit of co-pending International Patent Application No. DE Application No. 102010025724.9, which was filed Jul. 01, 2010, entitled “CUTTER BAR.” This reference is incorporated in its entirety herein.

### FIELD

The present embodiments generally relate to a cutter bar of a cutting device for producing pellets from strands of a strand material that emerges from a perforated plate in one or more strands and is cut into individual pellets by the cutting device.

### BACKGROUND

A need exists for a cutting device that prevents or reduces the likelihood that strands of material being cut by a cutting bar block or plug the cutting device.

A further need exists for a cutting device that eliminates or reduces the formation of non-uniform pellets.

A need also exists for a cutting device that avoids wear to the cutting bar due to the material strands “digging into” the cutter bar.

A need also exists for a cutting device that permits safe and reliable pelletizing with uniformly formed pellets with a simple design and is as economical as possible.

The present embodiments meet these needs.

### BRIEF DESCRIPTION OF THE DRAWINGS

The detailed description will be better understood in conjunction with the accompanying drawings as follows:

FIG. 1A is a schematic top view of a cutter bar according to an embodiment with strands running thereon.

FIG. 1B is a schematic cross-sectional view along the line A-A in FIG. 1A.

FIGS. 2A-2D are enlarged schematic cross-sectional views of various serration profiles of the cutter bar according to one or more embodiments.

FIG. 3 is a schematic top view of a cutting device according to one or more embodiments.

FIG. 4 is a schematic top view of a cutting device according to one or more embodiments.

FIG. 5 is a schematic top view of a section of a cutter bar according to one or more embodiments.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments generally relate to a cutter bar of a cutting device for producing pellets from strands of a strand material that emerges from a perforated plate in one or more strands and is cut into individual pellets by the cutting device.

The cutting device can be used to produce pellets from strands of material. The strands of material can emerge from a perforated plate in one or more strands. The emerging strands of material can be cooled and possibly dried. A cutting bar can be used to separate individual pellets from the strands of material.

In one or more embodiments, the cutter bar can have at least one cutting edge. The cutter bar can have a serration on at least one strand contact surface. The serration can have a preferential direction. The preferential direction can run in a straight line, which can be inclined at an angle relative to the cutting edge.

As a result of the angling of the serration, i.e. as a result of the inclination of the preferential direction of the serration relative to the cutting edge or to a strand of material running perpendicularly to the cutting edge in the customary manner, the strand of material is presented with a certain resistance to slipping on the cutter bar during the cutting process under the influence of knives rotating at an angle on a cutting roller of the cutting device.

The preferential direction when viewed in the direction of strand motion can be inclined away from the direction of displacement of the strand of material. The displacement of the strand of material can result from the knives rotating at an angle on the cutting roller of the cutting device.

In one or more embodiments, the preferential direction of the serration can be inclined at an angle in the range of up to about 10 degrees relative to the perpendicular of the cutting edge in a top view. For example, the serration can be inclined at an angle in the range of about 1 degree to about 5 degrees. In another example, the serration can be inclined at an angle in the range of about 1 degree to about 3 degrees.

The strand contact surface can have a increased resistance to the slipping of strands when the serration has a mean height difference (h) to the rest of the strand contact surface in the range from 100 μm to 500 μm. The mean height difference (h) can lie approximately in the range of about 2 percent to about 20 percent of the average strand diameter (e.g. 3 mm). In one or more embodiments, the serrations can be configured to prevent the stands of material from entering individual grooves of the serrations.

To further improve the running characteristics of the strands of material on the cutter bar, the strand contact surface can have flattened intermediate sections between individual serration sections of the serration. The flattened intermediate sections can have a width of about 50 μm to about 100 μm, so that the strands do not run completely on only these intermediate sections.

In one or more embodiments, the serration can be designed as serration grooves with a maximum width of individual serration grooves in the range from about 100 μm to about 500 μm.

In one or more embodiments, the serrations can be rhombic in design and arrangement, with a maximum width of individual serration sections thereof in the range from about 100 μm to about 500 μm.

In one or more embodiments, the inclination of the preferential direction of the serration in an installation situation of the cutter bar in the cutting device can extend such that the inclination is (also) present with respect to the direction of strand motion of the strands running on the strand contact surface.

In one or more embodiments, the cutter bar can have a first serration on a first strand contact surface with a first cutting edge and a second cutting edge and a second serration on an opposite second strand contact surface with a third cutting edge and a fourth cutting edge. Thus, the cutting edge can be used an additional time by turning it in the installation situation when the region of one of the cutting edges already shows signs of wear.

In one or more embodiments, the cutting device can be used for cutting strands into individual pellets, with a cutting rotor with at least one rotating cutter blade, and with a cutter bar with at least one cutting edge. The cutter bar can have a serration on at least one strand contact surface. The serration can be arranged with a preferential direction such that the preferential direction is inclined at an angle relative to the direction of strand motion of the strands running on the strand contact surface.

In one or more embodiments, the entire cutting device can be arranged at an inclination with respect to the direction of the strand motion of the strands of material, so that the effect resulting from the inclination can also be produced with a conventional cutter bar with serration extending perpendicularly to the cutting edge.

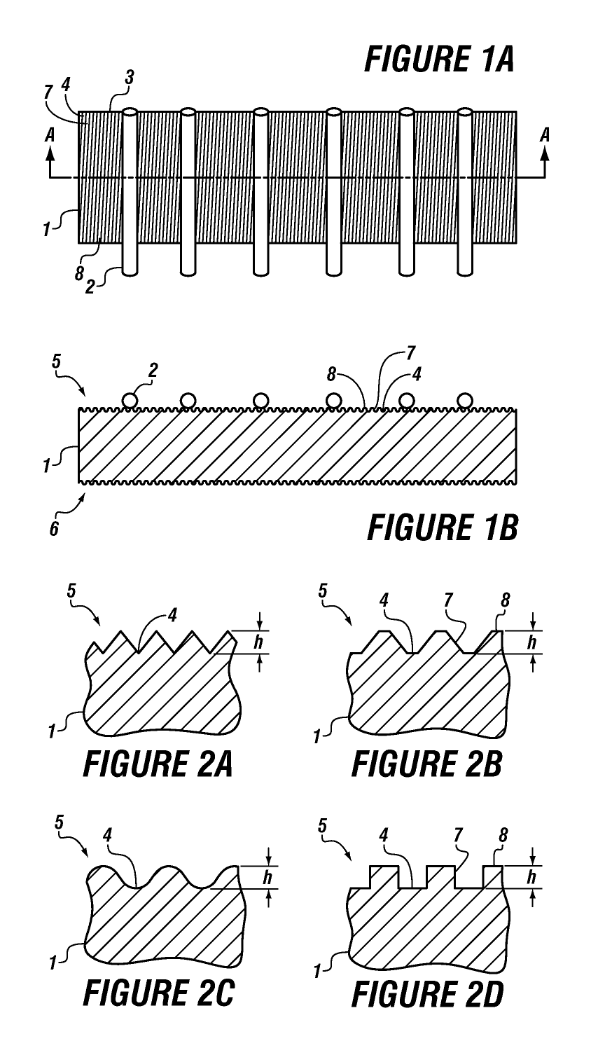

FIG. 1A shows a schematic top view of a cutter bar according to one or more embodiments with strands running thereon.

A cutter bar 1 can be used in a cutting device (not shown in FIG. 1A) for producing pellets from strands of material 2 that emerges from a perforated plate (not shown in FIG. 1A). The strands of material 2, can be cooled and possibly dried, and cut into individual pellets by the cutting device.

The cutter bar 1 can have at least one cutting edge 3. The cutter bar 1 can also have a serration 4 on at least its strand contact surface (not labeled in FIG. 1A).

The serration 4 can have a preferential direction that is inclined at an angle relative to the cutting edge 3. The preferential direction that is inclined at an angle in the range from up to about 10 degrees relative to the cutting edge 3 at an angle from the perpendicular of the cutting edge 3. For example, as shown, the preferential direction can be inclined at an incline of approximately 5 degrees. Individual serration sections 7 can have serrations 4. Flattened intermediate sections 8 can be adjacent the individual serration sections 7. The inclination of the preferential direction of the serration 4 in this design as shown in FIG. 1A is such that, even in an installation situation of the cutter bar in the cutting device, the inclination is (also) correspondingly present with respect to the direction of strand motion of the strands of material 2 running on the strand contact surface. The inclination of the preferential direction of the serration 4 of the cutter bar 1 in FIG. 1A in this design extends from the lower left to the upper right. The strands of material 2 can be feed such that they pass from bottom to top.

FIG. 1B shows a schematic cross-sectional view along the line A-A in FIG. 1A.

In the cross-sectional view shown in FIG. 1B, it is clearly visible that the cutter bar 1 can have two opposite strand contact surfaces 5 and 6, with each of the two having a serration 4. In this design, the serrations of both of the strand contact surfaces 5 and 6 are designed with the individual serration sections 7 and flattened intermediate sections 8. The flattened intermediate sections 8 can have a width of about 50 μm to about 100 μm. For example, the flattened intermediate sections 8, as shown, can have a width of approximately 80 μm. The mean height difference from the serrations 4 to the rest of the strand contact surfaces 5 and 6 lie in the range from about 100 μm to about 500 μm. For example, the height difference can be, as shown, of approximately 200 μm. This corresponds to approximately one tenth of the depicted strand diameter of the strands of material 2.

FIGS. 2A-2D show enlarged schematic cross-sectional views of various serration profiles of the cutter bar according to one or more embodiments.

FIG. 2A shows a saw tooth serration profile on the strand contact surface 5 with a serration depth h. The serrations 4 on the cutter bar 1 are designed as serration grooves having a maximum width of the individual serration grooves in the range from about 100 μm to about 500 μm. For example, the serration grooves, as shown, can have a maximum width of approximately 200 μm.

The serrations 4 on the cutter bar 1 as shown in FIG. 2B are designed with individual serration sections 7 of the individual serration grooves at each strand contact surface 5. The flattened intermediate sections 8 can be provided between the individual serration sections 7. The serration groove depressions of the individual serration sections 7 of the serrations 4 are also correspondingly flattened. The mean height difference (h) of the serrations 4 to the rest of the strand contact surface 5 is approximately 200 μm. The flattened intermediate sections 8 as well as the flattened regions of the serration groove depressions can have a width of about 50 μm to about 100 μm. For example, the flattened intermediate sections, as shown, can have a width of approximately 80 μm.

The strand contact surface 5, as shown in FIG. 2C, can have the serrations 4 of the cutter bar 1 designed such that the serration profile at the strand contact surface 5 is designed to be undulating in cross-section. The serrations 4 can be designed as serration grooves such that they are arranged with the bottom of the wave in the preferential direction extending at an angle. The height difference (h) as shown in FIG. 2C also lies in the range from about 100 μm to about 500 μm. For example, the height difference, as shown, can be approximately 200 μm.

The strand contact surface 5, as shown in FIG. 2D, can have the serrations 4 of the cutter bar 1 designed as stepped serrations 4 with individual serration sections 7 and flattened intermediate sections 8 and otherwise corresponds to the serrations of FIG. 2B with the single difference that the sides of the individual serration sections 7 of the serrations 4 are each of stepped design, and do not extend at an angle as is shown in FIG. 2B. The mean height difference (h) of the serrations 4 to the rest of the strand contact surface 5 is approximately 200 μm.

In addition to the symmetrical profiles of the serrations 4 shown in FIGS. 2A-2D, profiles that have an asymmetrical profile in a cross-sectional view are also possible.

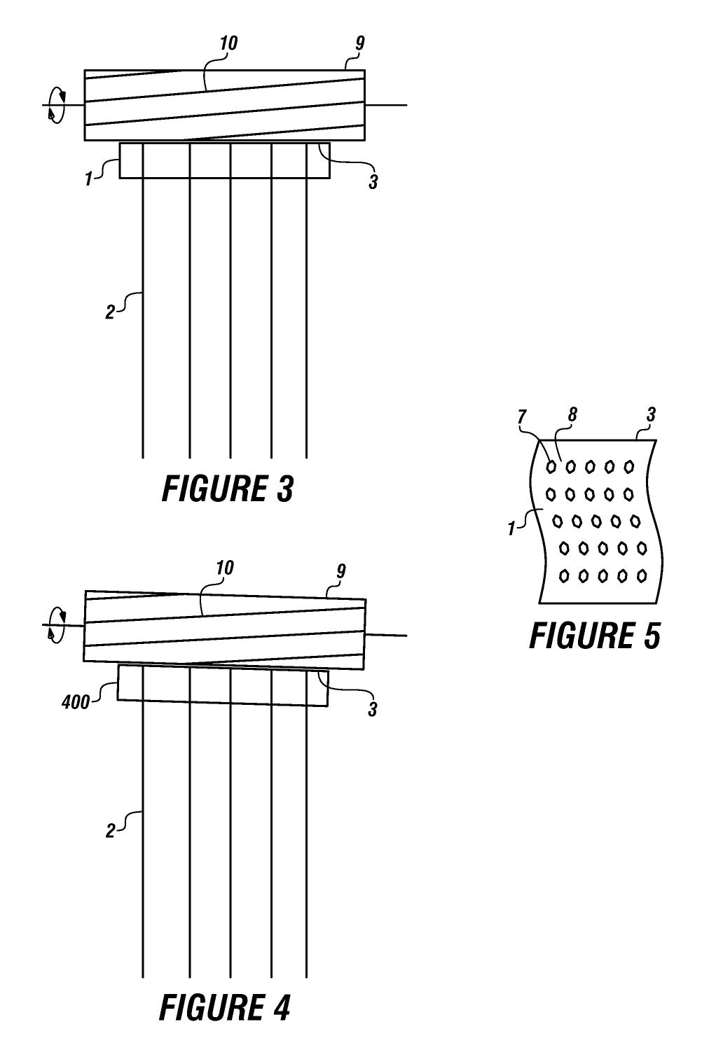

FIG. 3 shows a schematic top view of a cutting device in accordance with one or more embodiments.

The cutting device for cutting strands of material into individual pellets can have a cutting rotor 9 with at least one rotating cutter blade 10. The incoming strands of material 2 can be cut into pellets by the cutting device at the cutter bar 1 in the region of the cutting edge 3. The cutter bar 1 in this design corresponds to the cutter bar as described above. The characteristics described in this context also apply to the cutter bar 1 of the cutting device shown in FIG. 3. The inclination of the preferential direction of the serration of the cutter bar 1 in FIG. 3 in this design extends from the lower left to the upper right. The strands of material 2 are fed to the depicted cutting device passing from bottom to top.

FIG. 4 shows a schematic top view of a cutting device in accordance with one or more embodiments.

The cutting device for cutting strands of material into individual pellets can have a cutting rotor 9 with at least one rotating cutter blade 10. The embodiment of the cutting device according to the invention as shown in FIG. 4 differs from that shown in FIG. 3 in that a conventional cutter bar 400 with conventional serrations extending perpendicularly to the cutting edge 3 is provided in the representation in FIG. 4. The corresponding inclination of the serrations to the direction of strand motion is achieved by inclining the conventional cutter bar 400 or the entire cutting device relative to the direction of strand motion. In this way, the conventional cutter bar 400 can be used while still achieving the advantages of one or more described embodiments having the serrations set at an inclination relative to the direction of strand motion of the strands of material 2.

FIG. 5 schematically shows a top view of a section of a cutter bar in accordance with one or more embodiments.

The cutter bar 1 in FIG. 5 can have the serrations designed with individual serration sections 7 in the form of rhombic projections above flattened intermediate sections 8 of the strand contact surface. The rhombic projections of the individual serration sections 7 in this design have a height difference in the range from about 100 μm to about 500 μm. The height differential, as shown, can be approximately 200 μm, to the strand contact surface or to its corresponding flattened intermediate sections 8, and the rhombic projections are arranged in stripes with a corresponding preferential direction inclined to the cutting edge 3 of the cutter bar 1. The inclination of the preferential direction of the serrations of the cutter bar 1 in FIG. 5 in this design extends from the lower left to the upper right, and the strands of material (not shown in FIG. 5) are fed such that they pass from bottom to top.

While these embodiments have been described with emphasis on the embodiments, it should be understood that within the scope of the appended claims, the embodiments might be practiced other than as specifically described herein.

What is claimed is:

1. A cutter bar of a cutting device for producing pellets from a strand of material, wherein the strand material emerges from a perforated plate, and wherein the strands of material are cut into individual pellets by the cutting device, wherein the cutting device have at least one cutting edge, and wherein the cutter bar comprises: a serration on at least one strand contact surface, wherein the serration has a preferential direction that is inclined at an angle relative to the cutting edge.

2. The cutter bar of claim 1, wherein the preferential direction of the serration is inclined at an angle in the range of up to 10 degrees relative to the perpendicular of the cutting edge.

3. The cutter bar of claim 1, wherein the preferential direction of the serration is inclined at an angle in the range of 1 degree to 5 degrees.

4. The cutter bar of claim 1, wherein the preferential direction of the serration is inclined at an angle in the range of 1 degree to 3 degrees.

5. The cutter bar of claim 1, wherein the serration has a mean height difference to the rest of the strand contact surface in the range from 100 μm to 500 μm.

6. The cutter bar of claim 1, wherein the strand contact surface has flattened intermediate sections between individual serration sections of the serration, wherein the flattened intermediate sections have a width of 50 μm to 100 μm.

7. The cutter bar of claim 1, wherein the serration is designed as serration grooves with a maximum width of individual serration grooves in the range from 100 μm to 500 μm.

8. The cutter bar of claim 1, wherein the serration is rhombic in design and arrangement, with a maximum width of individual serration sections thereof in the range from 100 μm to 500 μm.

9. The cutter bar of claim 1, wherein the inclination of the direction of the serration during installation of the cutting bar into the cutting device is present with respect to the direction of strand motion of the strands of material running on the strand contact surface.

10. The cutter bar of claim 1, further comprising a first serration on a first strand contact surface with a first cutting edge and a second cutting edge, and a second serration on an opposite second strand contact surface with a third cutting edge and a fourth cutting edge.

11. A cutting device for cutting strands of material into individual pellets, having a cutting rotor with at least one rotating cutter blade, and a cutter bar with at least one cutting edge, the cutting device comprising: a serration on at least one strand contact surface of the cutter bar, wherein the serration is arranged with a preferential direction such that the preferential direction is inclined at an angle relative to the direction of strand motion of the strands of material running on the strand contact surface.

12. The cutting device of claim 11, wherein the entire cutting device is arranged at an inclination with respect to the direction of strand motion of the strands of material.

13. The cutting device of claim 11, wherein the preferential direction of the serration is inclined at an angle in the range of up to 10 degrees relative to the perpendicular of the cutting edge.

14. The cutting device of claim 11, wherein the preferential direction of the serration is inclined at an angle in the range of 1 degree to 5 degrees.

15. The cutting device of claim 11, wherein the preferential direction of the serration is inclined at an angle in the range of 1 degree to 3 degrees.

16. The cutting device of claim 11, wherein the serration has a mean height difference to the rest of the strand contact surface in the range from 100 μm to 500 μm.

17. The cutting device of claim 11, wherein the strand contact surface has flattened intermediate sections between individual serration sections of the serration, wherein the flattened intermediate sections have a width of 50 μm to 100 μm.

18. The cutting device of claim 11, wherein the serration is designed as serration grooves with a maximum width of individual serration grooves in the range from 100 μm to 500 μm.

19. The cutting device of claim 11, wherein the serration is rhombic in design and arrangement, with a maximum width of individual serration sections thereof in the range from 100 μm to 500 μm.

20. The cutting device of claim 11, wherein the inclination of the direction of the serration during installation of the cutting bar into the cutting device is present with respect to the direction of strand motion of the strands of material running on the strand contact surface.

21. The cutting device of claim 11, further comprising a first serration on a first strand contact surface with a first cutting edge and a second cutting edge, and a second serration on an opposite second strand contact surface with a third cutting edge and a fourth cutting edge.
